(19) United States
(12) Patent Application Publication
(10) Pub. No.: US 2022/0383358 A1
(43) Pub. Date: Dec. 1, 2022

(54) SCALABLE COUNTERBALANCING FRAMEWORK THAT PROMOTES INCREASED ENGAGEMENT OF INFREQUENT USERS

(71) Applicant: Microsoft Technology Licensing, LLC, Redmond, WA (US)

(72) Inventors: Ayan Acharya, Santa Clara, CA (US); Parag Agrawal, Mountain View, CA (US); Kinjal Basu, Stanford, CA (US); Aastha Jain, Sunnyvale, CA (US)

(21) Appl. No.: 17/335,850

(22) Filed: Jun. 1, 2021

(51) Int. Cl. G06Q 30/02; G06N 7/00

(52) U.S. Cl. CPC G06Q 30/0246; G06N 7/005

(57) ABSTRACT

Described herein is a technique for generating personalized scores for a cohort of users of an online service, where the scores are for use in ranking connection recommendations, in the context of generating connection recommendations for a user of the online service. The technique involves using a linear programming (LP) problem solver to solve a multi-objective optimization problem formulated to incorporate competing objectives and specific constraints. The technique allows for personalizing recommendations scores, specifically, to ensure that infrequent users are receiving invitations to connect with other users, thereby increasing overall interaction and engagement.

### TECHNICAL FIELD

The present application generally relates to a technical improvement in the manner by which an online service derives scores to rank connection recommendations. More specifically, the present application describes a technique that is used to generate connection recommendations, in part, by ranking each connection recommendation in accordance with a score that is derived at least in part by using a a linear programming (LP) problem solver to solve a multi-objective optimization problem.

### BACKGROUND

Many online services, such as social networking services, provide users with a way to memorialize real-world relationships by making connections with one another via the online service. With many online services, the establishment of connections between users is important to both users and to the entity operating the service, for a variety of reasons. First, from the perspective of an individual user, the overall experience one has with an online service tends to be significantly impacted by whether the user has a sufficient number of connections to other users. With many online services, the content that is presented to any given user is selected at least in part based on connections of the user. For example, many online services utilize what is often referred to as a feed—sometimes referred to as a content feed, or news feed. The content that a user is presented with in his or her personalized feed is often content that has been generated by, shared by, or is otherwise associated with, other users with whom the users has established a connection. Therefore, if a user has no connections with other users, or only a few connections, that user is not likely to find the content in his or her feed to be very interesting and may generally be dissatisfied with the online service. Of course, from the perspective of the entity operating the online service, having a well-connected user base is important because having satisfied users is important. If users are not satisfied with the experience, the users may choose not to use the service. This will of course have a negative impact on the success of the business.

### BRIEF DESCRIPTION OF THE DRAWINGS

Embodiments of the present invention are illustrated by way of example and not limitation in the figures of the accompanying drawings, in which:

FIG. 1 illustrates an example of a conventional connection recommendation service or system that is used to generate connection recommendations.

FIG. 2 illustrates an example of a social graph for an online service, illustrated as a graph with nodes (e.g., users) joined by edges (e.g., connections between users), where the users have been categorized as frequent users and infrequent users, consistent with an embodiment of the present invention.

FIG. 3 is a functional block diagram illustrating an example of an online service/system with which an embodiment of the present invention may be implemented and deployed.

FIG. 4 is a flowchart diagram illustrating an example of the various method steps involved with some embodiments of the present invention.

FIG. 5 is a block diagram illustrating a software architecture, which can be installed on any of a variety of computing devices to perform methods consistent with those described herein.

FIG. 6 illustrates a diagrammatic representation of a machine in the form of a computer system within which a set of instructions may be executed for causing the machine to perform any one or more of the methodologies discussed herein, according to an example embodiment.

### DETAILED DESCRIPTION

Described herein are methods and systems that provide a unified framework, incorporating different competing objectives and multiple constraints, for generating connection recommendations. In the following description, for purposes of explanation, numerous specific details and features are set forth in order to provide a thorough understanding of the various aspects of different embodiments of the present invention. It will be evident, however, to one skilled in the art, that the present invention may be practiced and/or implemented with varying combinations of the many details and features presented herein.

With many online services, such as online social networking services, the establishment of connections between users is important. One of the many ways that online services address this important issue is through a connection recommendation service, sometimes referred to as a People You May Know (PYMK) service or simply a friend suggestion service. A connection recommendation service is a recommendation service that presents recommendations to a user of the online service, with each recommendation indicating the identity of another user with whom the user may be interested in connecting. In addition to the identity of the user being recommended, each connection recommendation may include additional information about the other user being recommended as a new connection. Generally, with each recommendation presented, a user interface element (e.g., a button) provides an opportunity for the viewing user—the user viewing the recommendation—with an opportunity to quickly send an invitation to connect with the user being recommended.

In the context of the present disclosure, a connection recommendation involves two users—a first user to whom the recommendation is presented, and a second user that is the subject of the recommendation, or the user being recommended. For purposes of the present disclosure and in the context of a connection recommendation, the phrases “source user” or “viewing user” may be used to identify the user to whom a recommendation is being presented. The phrase “destination user” or the term “recomendee” may be used in reference to the user who is the subject of the recommendation—the user who is being recommended as a new connection. Furthermore, as described below, in terms of the canonical expression of the optimization problem described herein, the sub-script “i” is used to denote a source user, while the sub-script “j” is used to denote a destination user. Accordingly, when a connection recommendation is presented, it is presented to a source user denoted by the sub-script “i”, and that source user will have the ability to initiate a connection invitation that is communicated to the destination user, denoted by the sub-script “j”. As such, the destination user may accept the invitation, in order to form a user-to-user connection.

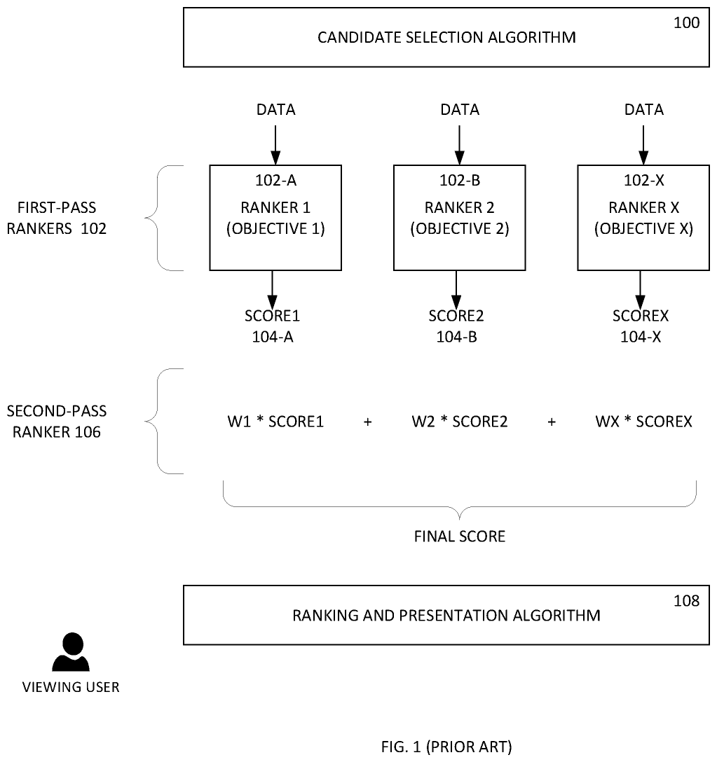

FIG. 1 illustrates an example of a conventional connection recommendation service or system that is used to generate connection recommendations. As shown in FIG. 1, a conventional connection recommendation service will first identify a pool of destination users from which a set of connection recommendations are to be selected for presentation to a source user. For instance, the candidate selection criteria applied by the candidate selection algorithm 100 may use any of a variety of coarse selection criteria to identify the pool of candidate destination users from which the connection recommendations are ultimately selected.

After the pool of candidate destination users are identified, various data relating to each candidate destination user and data relating to the source user to whom the recommendations are to be presented are provided as input data to several first-pass rankers 102. In this context, a first-pass ranker 102 is a ranking algorithm that is optimized for a single objective. By way of example, one first-pass ranker may be optimized to generate an output (e.g., a score 104-A) that reflects a measure of expected network growth (e.g., growth in user-to-user connections) that might result if a particular connection recommendation is presented to a user, and an actual user-to-user connection results. A second first-pass ranker 102-B may be optimized to ensure construction of a quality user-to-user network, such that the output (e.g., score 104-B) of the ranker 102-B reflects a measure of quality for the user-to-user connection that may result from the connection recommendation. As such, the input data to the ranker 102-B may be data reflecting characteristics of the users, such that the score 102-B is based on the extent to which the users share certain characteristics that may indicate a measure of expected interaction and engagement between the users, if in fact they formed a mutual connection in response to the connection recommendation. Another ranker may generate a score that reflects the likelihood that a source user, when presented with a connection recommendation, will take action to invite the destination user—the user being recommended as a possible new connection—to formally become a connection. Another first-pass ranker may generate a score to reflect the likelihood that a destination user—when invited to form a new connection—will accept the invitation. Accordingly, each first-pass ranker 102 generates a score that reflects a measure of the extent to which a particular pairing of a source user and a destination user will achieve a particular objective. Each first-pass ranker 102 may receive and process different sets of data to generate its respective score.

After the first-pass rankers 102 have generated their respective scores, a second pass ranker 106 facilitates the combination of the respective scores using a calculation that is referred to as a linear combination. In essence, each score derived by a first-pass ranker is weighted by a weighting factor (e.g., W₁, W₂ and W_{X} in FIG. 1) relevant to that specific score, before the products are summed to generate a final score for the connection recommendation. Finally, as illustrated with reference number 108, after final scores have been calculated for each pairing of a source and destination user, a final ranking is performed based on the respective final scores, and some set of candidate destination users with the highest final scores are selected for presentation to the source users as connection recommendations.

In many instances, some of the several objectives for which scores are derived by first-pass rankers 102 may be at odds with one another and are generally accompanied by multiple practical constraints that need to be accounted for methodically and perspicaciously using a scalable multi-objective optimization (MOO) framework. Accordingly, the outcome of such an endeavor must be a weighted combination of these conflicting objectives, where the weighting factor corresponding to an individual objective reflects its importance. For instance, as shown in FIG. 1, the weighting factor (“W₁”) reflects the importance of the score (“SCORE1”) generated by one first-pass ranker 102-A. However, with conventional ranking systems, many technical problems exist.

As illustrated in FIG. 1, a conventional recommendation service utilizes a second-pass ranker 106, which combines sub-scores derived by various first-pass rankers 102, using a linear weighted combination. One primary technical problem with this approach is that the system cannot incorporate any practical business constraints in any consistent way to influence the weighting factors. Instead, with a conventional technique, the weighting factors used in the linear combination are all hand-tuned—that is, individually selected and then manually adjusted—which frequently leads to a suboptimal ranking and loss in productivity by system developers. In this case, hand-tuning the weights may involve performing a variety of experiments and tests with different values for the weighting factors, in an attempt to derive optimal weighting factors. Isolating the impact of a change made to one weighting factor can be difficult. Additionally, the number of experiments grows linearly with the number of first-pass rankers. For instance, given a number “n” of different first-pass rankers and “k” possible values allowed for the weighting factors corresponding to different first-pass rankers, one has to experiment with (n−1)*k settings to arrive at the optimal values. This is often extremely expensive and time-consuming, in terms of both computational and human resources.

Another technical problem with a conventional connection recommendation service, such as that illustrated in FIG. 1, is that the individual weighting factors are set to common values for all users and not personalized for any one users, or group of users. This means that the preferences of individual users or various cohorts of users are never accounted for, which invariably leads to suboptimal ranking. For example, referring to the expression of the linear combination 106 in FIG. 1, the value of W₁—the weighting factor for the score, SCORE1—is disadvantageously set to be the same value for all connection recommendations.

Finally, the setting of global weighting factors that are the same for all users, as implemented with the conventional system illustrated in FIG. 1, exacerbates what might be referred to as a rich-get-richer problem. Specifically, certain users of an online service may be frequent users who regularly log-in to and use the online service, while interacting and engaging with a variety of content and other users. Similarly, some users may be categorized as infrequent users—that is, users who infrequently log-in to and use the online service. With respect to the rich-get-richer problem, the frequent users are the rich users, who, with the conventional connection recommendation service, tend to more frequently be recommended as new connections than the infrequent users. Thus, frequent user benefit at the expense of infrequent users, who are dispossessed of opportunities to establish new connections, because they less frequently are selected for presentation as new connections via the connection recommendation service.

To address the aforementioned technical problems, embodiments of the present invention leverage optimization software in the form of a linear programming (LP) problem solver library to solve an optimization problem formulated to incorporate competing objectives and specific constraints. As such, with embodiments of the present invention, the final scores that are generated for each connection recommendation when candidate destination users are being ranked by the connection recommendation service are programmatically determined with a data-driven strategy. Furthermore, as described in greater detail below, embodiments of the present invention provide for personalizing recommendations scores, specifically, to ensure that infrequent users are receiving invitations to connect with other users, thereby increasing overall interaction and engagement. Other advantages of the various embodiments of the present inventive subject matter will be readily apparent from the various descriptions of the figures that follow.

Embodiments of the present invention utilize linear programming (LP) to generate personalized weighting factors for use in ranking connection recommendations. Furthermore, the personalized weighting factors are specifically generated for a particular cohort of users that have been categorized as infrequent users—users that infrequently log-in to the online service. Those skilled in the art will recognize that linear programming (LP, also called linear optimization) is a method to achieve the best outcome in a mathematical model whose requirements are represented by linear relationships. Linear programming is a special case of mathematical programming (also known as mathematical optimization). More formally, linear programming is a technique for the optimization of a linear objective function, subject to linear equality and linear inequality constraints. Its feasible region is a convex polytope, which is a set defined as the intersection of finitely many half spaces, each of which is defined by a linear inequality. Its objective function is a real-valued affine (linear) function defined on this polyhedron. A linear programming algorithm finds a point in the polytope where this function has the smallest (or largest) value if such a point exists.

Linear programs are problems that can be expressed in canonical form as,

| | |
|---|---|
| Find a vector | x |
| That maximizes | c^{T}x |
| Subject to | Ax < B |
| And | x > 0 |

Here the components of x are the variables to be determined, while c and b are given vectors (with c^{T} indicating that the coefficients of c are used as a single-row matrix for the purpose of forming the matrix product), and A is a given matrix. The function whose value is to be maximized or minimized is called the objective function. The inequalities Ax≤b and x≥0 are the constraints which specify a convex polytope over which the objective function is to be optimized. In this context, two vectors are comparable when they have the same dimensions. If every entry in the first is less-than or equal-to the corresponding entry in the second, then it can be said that the first vector is less-than or equal-to the second vector.

As will be described in greater detail below, embodiments of the present invention involve the formulation of an LP optimization problem, for which a dual variable expressed in the primal solution takes on a value that is stored in connection with a user identifier for an infrequent user. The value of the dual variable is ultimately used as a personalized weighting factor when generating a final ranking score for the destination user for which the dual value was derived. Because a positive value of the dual value increases the overall ranking score of a user, the solution described herein ultimately provides a more equitable ranking by increasing the likelihood that infrequent users are invited by others to form user-to-user connections.

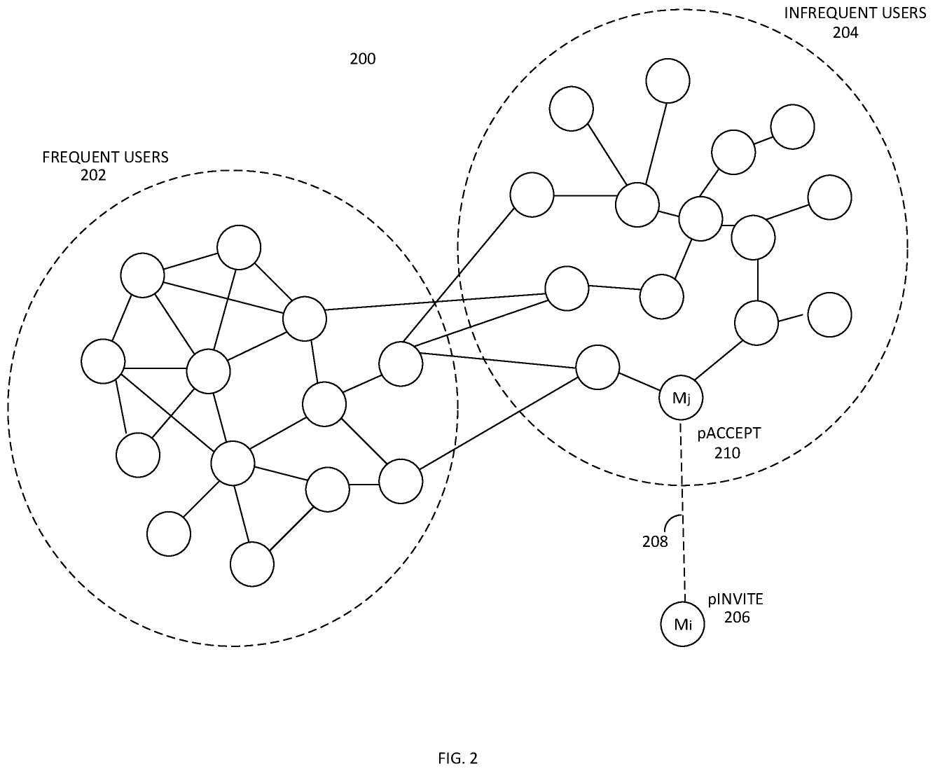

FIG. 2 illustrates an example of a social graph 200 for an online service, illustrated as a graph with nodes (e.g., users) joined by edges (e.g., connections between users), and categorized as frequent users and infrequent users, consistent with an embodiment of the present invention. As users connect with one another via the online service, a graph database is updated to reflect the connections between the users. As illustrated in FIG. 2, a social graph can be conveyed as a graph, where each node represents a user, and each line (e.g., edge) connecting two nodes represents a connection that has been formed between the users. Accordingly, as a general matter, one of the objectives of any connection recommendation service is to enhance the social graph by encouraging specific users to connect with one another.

As illustrated in FIG. 2, the large circle 202 enclosing one set of users represents a group or cohort of users who have been classified as frequent users, whereas the group or cohort of users enclosed by the circle with reference number 204 represents a group of users who have been classified as infrequent users. Consistent with some embodiments of the present invention, a software algorithm is used to analyze data that has been logged in a user activity database to identify the frequency with which various users log-in to the online service. Based on this data, each users may be classified as a frequent users or an infrequent user. Although the exact definition may vary from one implementation or embodiment to the next, consistent with some embodiments, a frequent user is any user who, on average over some predetermined amount of time, has logged into the online service more than one time per week. Similarly, an infrequent user may be defined as any user who, on average over the predetermined amount of time, has logged into the online service less than one time per week. Of course, in various embodiments, the exact definition, and the specific formula or calculation for making such determinations of who is a frequent user or an infrequent user may vary.

Another concept illustrated in FIG. 2 involves two specific scores that may be derived by two first-pass rankers used in a connection recommendation service. For example, as illustrated in FIG. 2, assume a scenario for which connection recommendations are to be generated for a source user, Uᵢ. The user designated as Uⱼ in FIG. 2 is a candidate destination user for consideration as a connection recommendation to be presented to the user, Uᵢ. A first score—the invitation probability score (referred to as a “pInvite score”) 206—is generated by a first first-pass ranker to reflect the probability that the source user, Uᵢ, when presented with a recommendation to form a connection 208 with destination user, Uⱼ, will actually send an invitation to Uⱼ. The first-pass ranker that is used to generate the invitation probability score (“pInvite”) 206 may utilize a machine learned model that takes as input a wide variety of information about each user, Uᵢ and Uⱼ. Based on the information, the first-pass ranker applies the information as feature inputs to the machine learned model and outputs the invitation probability score 206. Specifically, the information used to generate the invitation probability score 206 may include information from the respective user profiles of the users, activity data relating to the users and their various interactions with content via the online service, and social graph information—for example, indicating how many mutual connections that the users have, and so on.

A second first-pass ranker derives a score, the acceptance probability score (“pAccept score” for short) 210, to reflect the probability that the user, Uⱼ, if actually invited to connect with the user, Uᵢ, will accept the invitation to formally establish the user-to-user connection. The ranker used to generate the acceptance probability score 210 may also utilize a machine learned model to generate the pAccept score 210. Generally, the information provided as input to the machine learned model may be similar to that used by the ranker that generates the invitation probability score. For example, the input to the model for the first-pass ranker used to generate the acceptance probability score may include data relating to the user profiles of the respective users, data relating to the social graph, and/or any of a wide variety of activity data relating to actions and interactions that the users have had via the online system/service 100.

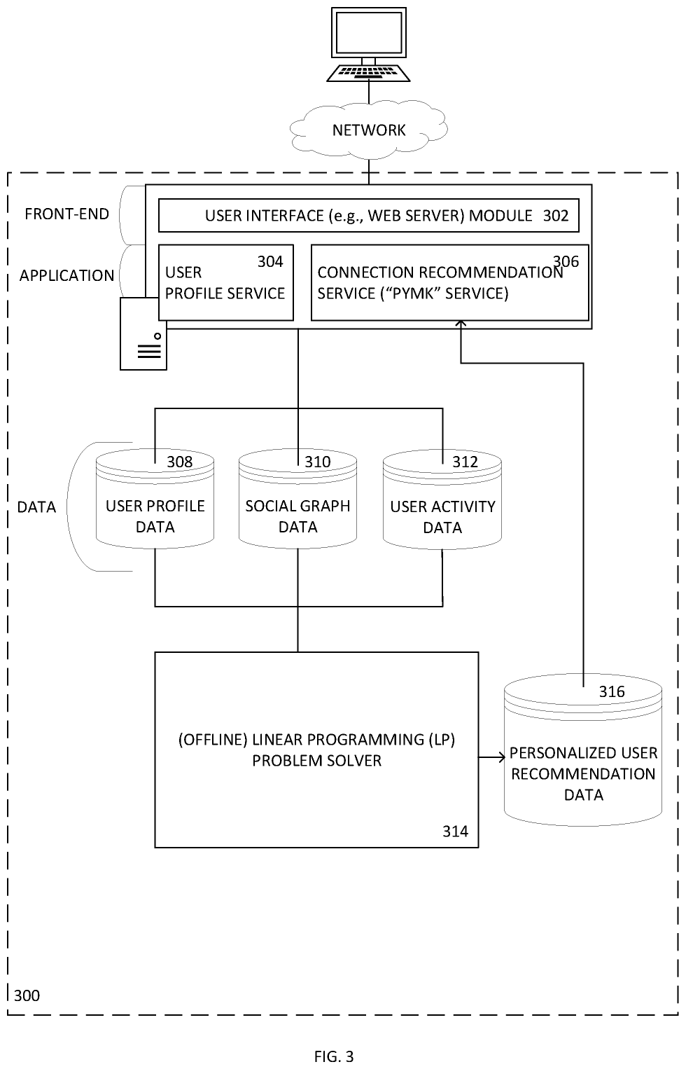

FIG. 3 is a functional block diagram illustrating an example of a service/system 300 with which an embodiment of the present invention may be implemented and deployed. As shown in FIG. 3, a front-end layer comprises a user interface module (e.g., a web server) 302, which receives requests from various client computing devices and communicates appropriate responses to the requesting client devices. For example, the user interface module(s) 302 may receive requests in the form of Hypertext Transfer Protocol (HTTP) requests or other web-based API requests.

An application logic layer may include one or more application server modules, which, in conjunction with the user interface module(s) 302, generate various user interfaces (e.g., web pages) with data retrieved from various data sources in a data layer. Consistent with some embodiments, individual application server modules implement the functionality associated with various applications and/or services provided by the online system/service 300. For instance, the application logic layer may include a variety of applications and services such as a user profile service 304 and a connection recommendation service 306, among others.

Consistent with some embodiments, the user profile service 304 provides a user with the ability to register with the online service and provide information to be included as part of the user's user profile. By way of example, the user profile service 304 may prompt the user to enter his or her name, contact information (e.g., email address, phone number, residential address), as well as information about the user's current and past employment. For instance, the user may be prompted to provide the names of the user's current and/or past employers, as well as the job titles of any positions the user currently has or previously held with those employers, and the dates on which employment began and/or ended. As information is provided, the user profile service 304 stores the information in one or more databases, such as the database illustrated in FIG. 3 with reference number 308. Some, or all, of the information added by a user to his or her user profile may be accessible to other users via a user profile page.

Once registered, a user may invite other users, or be invited by other users, to connect via the online service/system 300. A “connection” may constitute a bilateral agreement by the users, such that both users acknowledge and agree to the establishment of the connection. When one user forms a connection with another, the user may receive status updates relating to the other user, or other content items published or shared by the other user with whom the connection has been formed. In addition to forming connections, a user may “follow” another user, or another company, educational institution or organization. When a user follows another user or organization, the user becomes eligible to receive status updates that are relating to the user or organization as well as any content items published by, or on behalf of, the user or organization. For instance, content items published by a user with whom another user is connected, or on behalf of an organization that a user is following may appear in the user's personalized feed, sometimes referred to as a news feed. In any case, the various associations and relationships that each user establishes with other users, or with other organizations and objects (e.g., metadata hashtags (“#topic”) used to tag content items), are stored and maintained within a database, such as the social graph database with reference number 310.

With some embodiments, the online service/system 300 may provide a number of other integrated applications and/or services. By way of example, a company profile service (not shown) may allow a user to generate and administer a company profile page that includes various information about a company or other organization. A job hosting service (not shown) may provide users with the ability to post online job postings that are then searchable by users, and in some instances, presented to users via a job recommendation service. Another application or service is a feed via which content and status updates are presented to each user, in a personalized manner such that the particular content that is presented is selected based on the content being associated with another user to which the viewing user is connected. The aforementioned applications and services are presented here as examples and are not meant to be an exhaustive listing of all applications and services that may be integrated with and provided as part of an online service.

Although not shown in FIG. 3, a separate application or service, referred to herein as a user activity tracking service, may operate to log actions taken by users. For example, when a user interacts with content presented in the feed, that interaction may be logged for subsequent use in generating a recommendation. With some embodiments, each time a user logs-in to the online service, an event is logged to indicate the specific day and time that the user logged in. This logged data can be subsequently analyzed for the purpose of classifying or categorizing each user as a frequent user or an infrequent user. With some embodiments, and as illustrated in FIG. 3, this user activity data is stored in a user activity database 312.

As shown in FIG. 3, the data layer may include several databases, such as the user profile database 308 for storing user profile data generated with the user profile service 304. Additionally, as shown in FIG. 3, the data layer includes a database for storing social graph data 310 relating to information about relationships between users and various other entities. Finally, the data layer may include one or more databases 312 storing data relating to various interactions that users have with the online service/system 300.

As illustrated in FIG. 3, the online service includes a connection recommendation service 306, which may be known as a People You May Know (“PYMK”) service. The connection recommendation service 306 generates connection recommendations. Consistent with embodiments of the present invention, the connection recommendation service 306 has both an online component and an offline component. For instance, the offline component involves the linear programming problem solver 314, which, through solving an optimization problem, generates personalized scores for all infrequent users. These scores are stored in a database, such as that with reference number 316 in FIG. 3. Then, at run time, when a user selects to view a particular user interface associated with the connection recommendation service, a request is generated and directed to the connection recommendation service 306. At run time, the request is processed in part by obtaining the personalized ranking scores from the database 316 and using the personalized ranking scores to rank a set of candidate connection recommendations, prior to selecting some set of the highest-ranking recommendations for presentation to the requesting user.

Turning now to the linear programming (LP) optimization problem at hand, consistent with some embodiments of the present invention the LP problem may be linguistically formulated as follows. The objective of the LP problem is to maximize the expected total number of invitations sent by a source user. For example, the connection recommendation service will present some predetermined number of recommendations to a given source user. When that given source user is presented with the connection recommendations, the presentation of each recommendation includes a user interface element (e.g., a button) that allows the user to quickly send the recommendee an invitation to connect via the service. Accordingly, the objective of the LP problem is to maximize the number of invitations that are sent by a given source user, as a result of that user being presented with a set of connection recommendations. Of course, as described immediately below, the objective is subject to constraints—in this instance, three specific constraints.

The first constraint of the LP problem as formulated herein is that, for a particular user who is presented with a set of connection recommendations, the expected number of connections resulting from the presentation of the connection recommendations is to be higher than a first threshold, for a given time period (e.g., one day). In this instance, the first threshold is a threshold that is a value dictated by the operating entity—the entity operating the service. For example, the value of the first threshold may be set as a business requirement.

The second constraint of the LP problem as formulated is that, for a particular user who is presented with a set of connection recommendations, the total measure of impressions associated with any connections that result from invitations arising from the recommendations is less than a given value. By way of example, assume a first user is presented with a set of connection recommendations, and that first user sends out fifteen invitations resulting in fifteen new connections. If the first user goes on to have interactions with ten of those new connections, then the number of resulting impressions from the connection recommendations would be ten. Accordingly, an expected impression, in this context, is in essence an interaction between two users via the online service. This interaction may be an exchange of direct messages using a messaging service, or any number of interactions that occur via a feed (e.g., sharing content directly with another user, commenting on a user's content posting, etc.). As the second constraint is expressed to constrain or limit (e.g., be less than) the expected number of impressions, this constraint serves as a damper on the frequent users, thereby addressing the rich-get-richer problem by ensuring that no one user gets to monopolize the system by sending out too many connection invitations.

Finally, the third constraint can be linguistically expressed as requiring that the expected number of invitations that are sent by a user to other users who are categorized as infrequent users does not drop below a certain threshold. This final constraint is aimed to ensure that each infrequent user receives a certain number of invitations to connect with other users. This prevents the frequent users from plundering all of the connection invitations that are sent.

The description of the formulation of the LP problem as described above in a linguistic manner, will now be more formally (e.g., canonically) described. As will be readily apparent, the formulation of the LP problem results in a dual variable that contributes to the generation of personalized weighting factors and caters to the customization of generating scores for the connection recommendations, thereby relieving the system developers from the burden of iteratively experimenting to find optimal weighting factors. The LP problem can be formally expressed as follows,

$$Maximize {\sum }_{i} {\sum }_{j ∈ S} {x}_{ij} {p}_{ij}^{1} s . t .$$

subject to the constraints,

$$\begin{matrix}{\sum }_{ij} {x}_{ij}^{1} {p}_{ij}^{1} {p}_{ij}^{2} \geq c \\ {\sum }_{j} {x}_{ij} \leq {δ}_{i} \\ {\sum }_{i} {x}_{ij} {p}_{ij}^{1} \geq 1 {∀}_{j} ∈ S = IMs \\ 0 \leq {x}_{ij} \leq 1\end{matrix}$$

In the expression above, the sub-scripts “i” and “j” are used to denote a source user (“i”) and a destination user (“j”), respectively. The set of destination users (“j”) is limited to the set of infrequent users. Accordingly, the variables pᵢⱼ¹ and pᵢⱼ² represent the pInvite score 206 and the pAccept score 210, respectively, as derived by their respective first-pass rankers. As described above, the pInvite score 210 represents the probability that a given source user (“i”), when presented with a connection recommendation for a particular destination user (“j”), will send that destination user (“j”) an invitation to connect. On the other hand, the pAccept score 210 represents the probability that a destination user (“j”) receiving an invitation to connect with a source user (“i”), will actually accept the invitation to form the new user-to-user connection. Hence, the product of the two terms, pᵢⱼ¹pᵢⱼ², represents the probability of a connection being formed. In the expression above, the variables {xᵢⱼ}'s are the variables for which the LP solver is attempting to optimize. Physically, this variable represents the probability of an impression being generated between the source (“r”) and destination (“j”) users. When these probabilities are derived by solving the LP problem formulation, for each user-to-user pairing associated with a connection recommendation, these probabilities can be used in the generation of the rankings of connection recommendations, thereby enabling the selection of connection recommendations with higher scores to facilitate a more equitable distribution of connections. Specifically, as compared with the conventional approach, infrequent users, who have a positive xᵢⱼ will tend to have a higher ranking, and ultimately be more likely to be invited to connect with other users.

To further clarify, the corresponding primal solution of the above objective is given by the expression: xᵢⱼ=(1+λⱼ)pᵢⱼ¹+αpᵢⱼ², where λⱼ is a dual variable corresponding with the constraints imposed on the expected number of invitations for the j-th infrequent user. Some advantages of the present invention can be ascertained by simply comparing the primal solution of the LP problem as set forth above with an expression for a conventional model: xᵢⱼ=pᵢⱼ¹+αpᵢⱼ¹pᵢⱼ². In the conventional model, the value for the variable alpha (“α”) must be hand-tuned, and is the same for all users. In contrast, in accordance with embodiments of the present invention, the learned value of λⱼ is determined on a per user basis, for all infrequent users. A higher value of λⱼ yields a higher ranking score and hence the corresponding infrequent user is promoted within the ranked list of connection recommendations.

As will be described in greater detail below, although the large-scale LP problem solver 314 is designed to solve problems at enormous scale, the number of constraints for a given problem, dictated by the total number of users considered, poses significant challenges to its adoption in this context. Therefore, the offline component of the connection recommendation service 306 is divided into two workflows. As part of a first workflow, user profiles are first clustered by one or more common characteristics, using a K-means clustering algorithm, to generate clusters of user profiles sharing in common the one or more common characteristics. Then, from each cluster, some fraction or portion of user profiles are sampled to formulate the dataset for the LP problem solver 314. For instance, for the sampled set of user profiles, data relevant to solving the LP problem are obtained from the various databases in the data layer. The linear programming problem is then solved for the sampled set of user profiles, and the resulting scores for the sampled set of user profiles are stored in connection with the user identifier of the user for which the score was derived. By way of example, the scores may be stored in the database with reference 316.

Next, as part of a second workflow, the entire user base is considered, including those users not selected as part of the user profile sampling in the first workflow. The scores that were derived for the sampled user profiles are assigned to other users in the same cluster, thereby providing all user profiles with a score for use with the connection recommendation service 306.

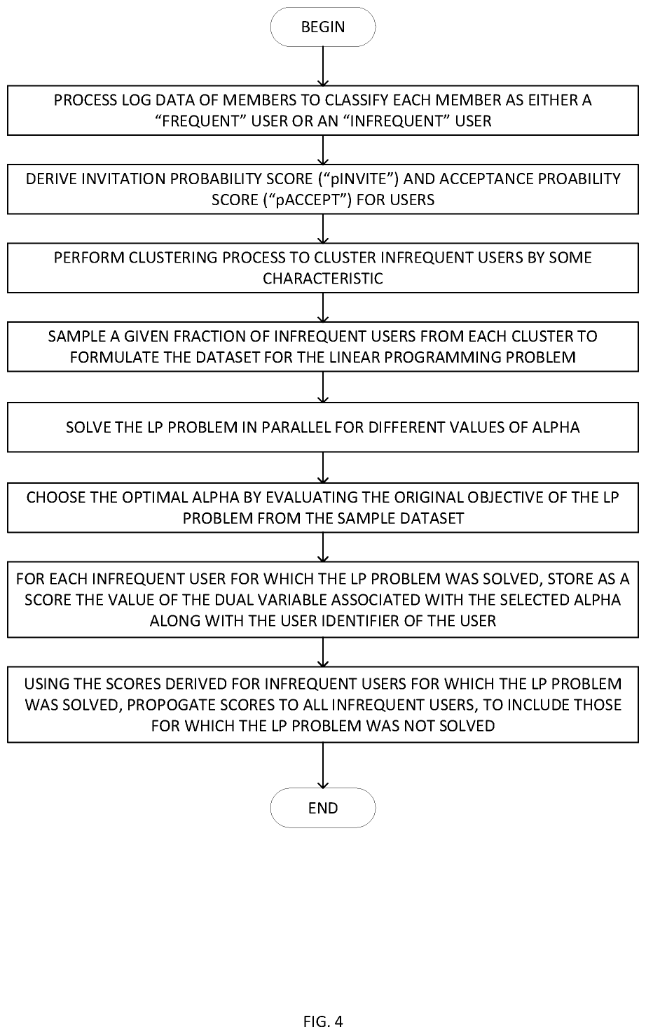

FIG. 4 is a flowchart diagram illustrating an example of the various method steps involved with some embodiments of the present invention. The method operations illustrated in FIG. 4 are those operations involved in generating for each infrequent user a score that is based on the value of a dual variable associated with the primal solution of the LP problem. At least with some embodiments, due to the massive scale of the problem generally—for example, the extremely large number of users for which the LP problem is solved—the LP problem is solved for a subset of users. Then, based on the scores that are generated for the subset of users by solving the LP problem, those users for which the LP problem was not solved are assigned or allocated a score that is based on a score that was derived for another user who shares in common one or more characteristics. Accordingly, the various method operations illustrated in FIG. 4 and described below can be logically divided into two separate workflows. During the first workflow, the LP problem is solved to generate scores for a first subset of infrequent users. Then, during the second workflow, scores are assigned or allocated to users in the second subset—specifically, those users that were not selected for inclusion in the first subset, and thus, did not have a score assigned by virtue of solving the LP problem.

As illustrated in FIG. 4, the method operations begin at method operation 402 when a software algorithm or routine processes log data obtained from a database to classify each user as either a frequent user, or an infrequent user. As described above, the log data indicates for each user the days and times at which the user logged in to the online service. Accordingly, depending upon the frequency that a user logs in to the online service, the user may be classified as either a frequent user or an infrequent user. While the specific definition of a frequent user and infrequent user may vary from one implementation to the next, with some embodiments a frequent user is a user who has logged into the online service at least one time per week on average, over some duration of weeks. Similarly, with some embodiments, an infrequent user may be a user who has logged in, on average, less than one time per week over a given duration of weeks.

Next, at method operation 404, data relating to the users is obtained from the various databases in the data layer to derive invitation probability scores and acceptance probability scores. As described above, an invitation probability score, or “pInvite” score, is a score that represents the probability that a particular source user will, when presented with a connection recommendation identifying a specific destination user, invite the destination user to connect. Similarly, the acceptance probability score, or “pAccept” score, is a score that represents the probability that a particular destination user, when invited to connect with a specific source user, will accept the invitation. Generally, these scores are derived using machine learned models that take as input a combination of profile data relating to the source and destination users, activity data of the respective users, and in some instances, social graph data relating to network of connections of the respective users.

At method operation 406, a clustering algorithm is performed to generate various clusters of destination users, who in this instance are limited to the set of infrequent users. Consistent with some embodiments, the destination users are clustered based on their respective invitation probability scores (“pInvite” scores). For example, the infrequent users are compared based on their non-zero pInvite scores. For the j-th infrequent user, the scores are given by {pᵢⱼ¹}ᵢ. The percentiles of these scores are calculated at each decile, which becomes the representation of each destination user, j. Then, at least with some embodiments, a K-means clustering algorithm is used to cluster the infrequent users based on their respective pInvite scores. The result is a set of clusters of infrequent users, clustered or grouped together by their respective pInvite scores.

Next, at method operation 408, from each cluster, a sample of infrequent users is taken. Specifically, from each cluster, a fraction of the infrequent users are selected, and from these selected infrequent users a dataset is derived for use in solving the LP problem. Accordingly, the LP problem is solved for only a subset of users. At method operation 410, the LP problem is solved using the large-scale LP problem solver, in parallel for different values of alpha. At method operation 412, the optimal value of alpha is selected by evaluating the original objective of the LP problem from the sampled dataset. At method operation 414, the first offline workflow is completed by storing, for each infrequent user for which the LP problem was solved, the value of the dual variable (e.g., λⱼ) that corresponds with the selected optimal value of alpha. The value of the dual variable is stored in a data record in association with the user identifier of the user for which it was derived.

Finally, at method operation 416, a second offline workflow is initiated to assign or allocate scores (e.g., values of the dual variable, λⱼ) to those users who were not selected as part of the sampling operation (e.g., method operation 408). Accordingly, for any infrequent user, indexed by j, not selected for including the dataset in the LP problem/solution, a nearest neighbor algorithm is used with the original feature space (e.g., pInvite scores), dictated by the percentile measures, and then a value for λⱼ is calculated based on the nearest neighbors. In this way, infrequent users in a cluster who were not selected based on the sampling operation are assigned scores derived from the scores of these users from the same cluster who were selected during the sampling operation. Consistent with some embodiments, a nearest neighbor strategy can be applied for some set of q nearest neighbors, where the value of λⱼ is calculated as, λⱼ=1/|Nⱼ|Σλⱼ′ where j′ refers to the set of infrequent users selected during the sampling operation for inclusion in the LP problem/solution.

During run time, the score (e.g., the value of the variable, λⱼ) stored for each infrequent user is used as a weighting factor to generate the final ranking scores for connection recommendations. Because the scores are derived in the manner described herein, the cohort of users who are classified as infrequent users stand a better chance of being selected for inclusion in a set of connection recommendations presented to a source user. Furthermore, the scores are personalized to each infrequent user.

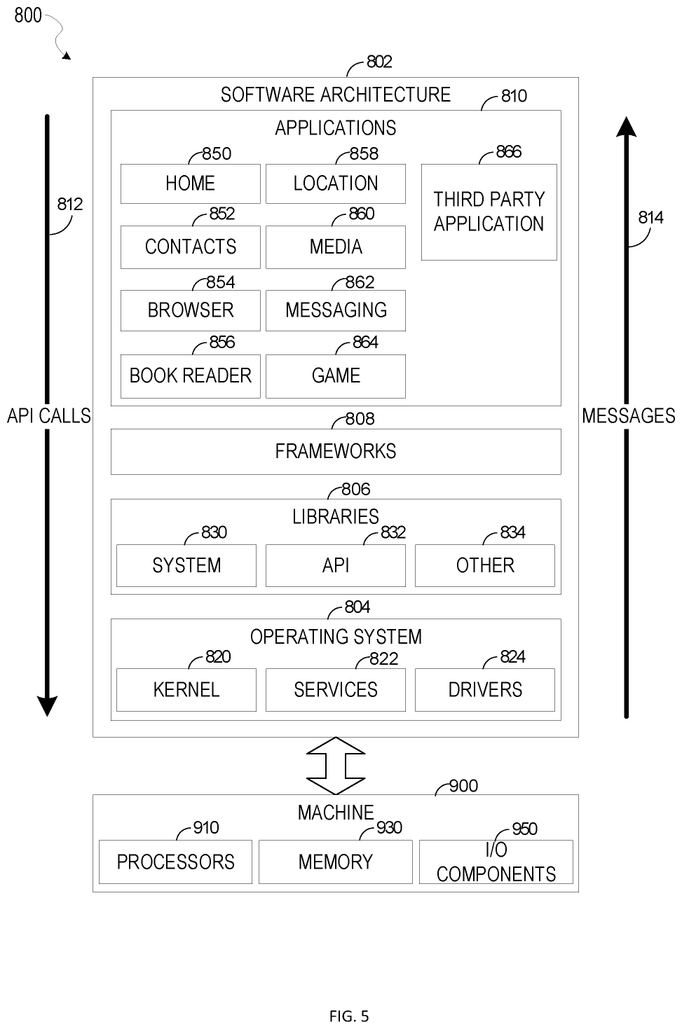

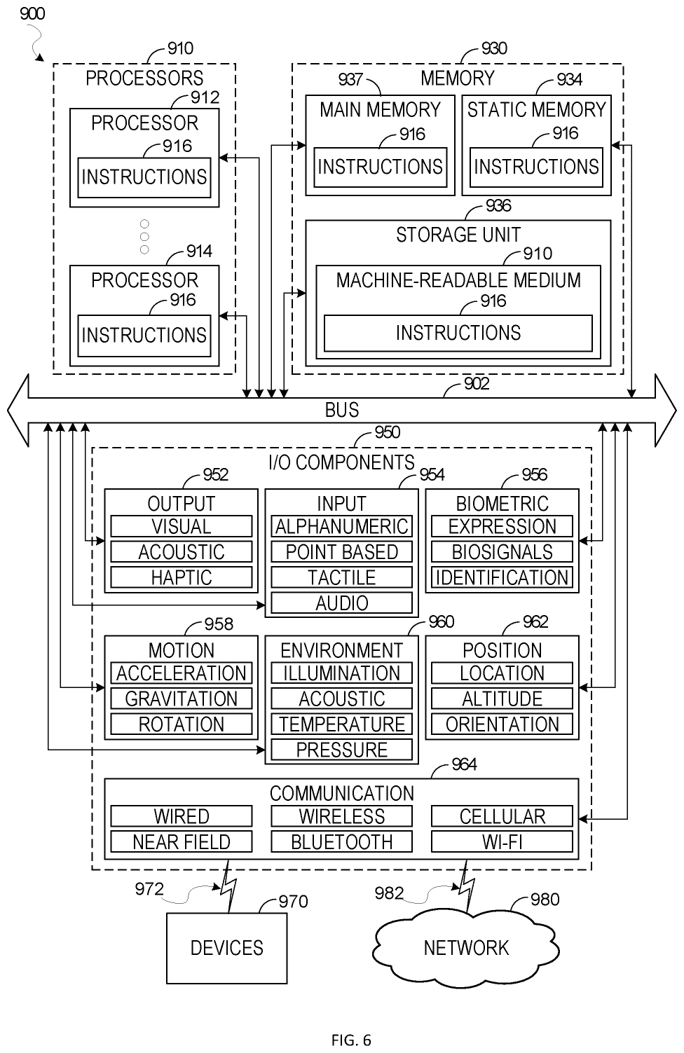

FIG. 5 is a block diagram 800 illustrating a software architecture 802, which can be installed on any of a variety of computing devices to perform methods consistent with those described herein. FIG. 5 is merely a non-limiting example of a software architecture, and it will be appreciated that many other architectures can be implemented to facilitate the functionality described herein. In various embodiments, the software architecture 802 is implemented by hardware such as a machine 900 of FIG. 6 that includes processors 910, memory 930, and input/output (I/O) components 950. In this example architecture, the software architecture 802 can be conceptualized as a stack of layers where each layer may provide a particular functionality. For example, the software architecture 802 includes layers such as an operating system 804, libraries 806, frameworks 808, and applications 810. Operationally, the applications 810 invoke API calls 812 through the software stack and receive messages 814 in response to the API calls 812, consistent with some embodiments.

In various implementations, the operating system 804 manages hardware resources and provides common services. The operating system 804 includes, for example, a kernel 820, services 822, and drivers 824. The kernel 820 acts as an abstraction layer between the hardware and the other software layers, consistent with some embodiments. For example, the kernel 820 provides memory management, processor management (e.g., scheduling), component management, networking, and security settings, among other functionality. The services 822 can provide other common services for the other software layers. The drivers 824 are responsible for controlling or interfacing with the underlying hardware, according to some embodiments. For instance, the drivers 824 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 806 provide a low-level common infrastructure utilized by the applications 810. The libraries 606 can include system libraries 830 (e.g., C standard library) that can provide functions such as memory allocation functions, string manipulation functions, mathematic functions, and the like. In addition, the libraries 806 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 806 can also include a wide variety of other libraries 834 to provide many other APIs to the applications 810.

The frameworks 808 provide a high-level common infrastructure that can be utilized by the applications 810, according to some embodiments. For example, the frameworks 608 provide various GUI functions, high-level resource management, high-level location services, and so forth. The frameworks 808 can provide a broad spectrum of other APIs that can be utilized by the applications 810, some of which may be specific to a particular operating system 804 or platform.

In an example embodiment, the applications 810 include a home application 850, a contacts application 852, a browser application 854, a book reader application 856, a location application 858, a media application 860, a messaging application 862, a game application 864, and a broad assortment of other applications, such as a third-party application 866. According to some embodiments, the applications 810 are programs that execute functions defined in the programs. Various programming languages can be employed to create one or more of the applications 810, structured in a variety of manners, such as object-oriented programming languages (e.g., Objective-C, Java, or C++) or procedural programming languages (e.g., C or assembly language). In a specific example, the third-party application 866 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 866 can invoke the API calls 812 provided by the operating system 804 to facilitate functionality described herein.

FIG. 5 illustrates a diagrammatic representation of a machine 900 in the form of a computer system within which a set of instructions may be executed for causing the machine to perform any one or more of the methodologies discussed herein, according to an example embodiment. Specifically, FIG. 5 shows a diagrammatic representation of the machine 900 in the example form of a computer system, within which instructions 916 (e.g., software, a program, an application, an applet, an app, or other executable code) for causing the machine 900 to perform any one or more of the methodologies discussed herein may be executed. For example the instructions 916 may cause the machine 900 to execute any one of the methods or algorithms described herein. Additionally, or alternatively, the instructions 916 may implement a system described in connection with FIG. 3, and so forth. The instructions 916 transform the general, non-programmed machine 900 into a particular machine 900 programmed to carry out the described and illustrated functions in the manner described. In alternative embodiments, the machine 900 operates as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment. The machine 900 may comprise, but not be limited to, a server computer, a client computer, a PC, a tablet computer, a laptop computer, a netbook, a set-top box (STB), a PDA, an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 916, sequentially or otherwise, that specify actions to be taken by the machine 900. Further, while only a single machine 900 is illustrated, the term “machine” shall also be taken to include a collection of machines 900 that individually or jointly execute the instructions 916 to perform any one or more of the methodologies discussed herein.

The machine 900 may include processors 910, memory 930, and I/O components 950, which may be configured to communicate with each other such as via a bus 902. In an example embodiment, the processors 910 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 912 and a processor 914 that may execute the instructions 916. The term “processor” is intended to include multi-core processors that may comprise two or more independent processors (sometimes referred to as “cores”) that may execute instructions contemporaneously. Although FIG. 9 shows multiple processors 910, the machine 900 may include a single processor with a single core, a single processor with multiple cores (e.g., a multi-core processor), multiple processors with a single core, multiple processors with multiples cores, or any combination thereof.

The memory 930 may include a main memory 932, a static memory 934, and a storage unit 936, all accessible to the processors 910 such as via the bus 902. The main memory 930, the static memory 934, and storage unit 936 store the instructions 916 embodying any one or more of the methodologies or functions described herein. The instructions 916 may also reside, completely or partially, within the main memory 932, within the static memory 934, within the storage unit 936, within at least one of the processors 910 (e.g., within the processor's cache memory), or any suitable combination thereof, during execution thereof by the machine 900.

The I/O components 950 may include a wide variety of components to receive input, provide output, produce output, transmit information, exchange information, capture measurements, and so on. The specific I/O components 950 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 9. The I/O components 950 are grouped according to functionality merely for simplifying the following discussion and the grouping is in no way limiting. In various example embodiments, the I/O components 950 may include output components 952 and input components 954. The output components 952 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 954 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 950 may include biometric components 956, motion components 958, environmental components 960, or position components 962, among a wide array of other components. For example, the biometric components 956 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 962 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 950 may include communication components 964 operable to couple the machine 900 to a network 980 or devices 970 via a coupling 982 and a coupling 972, respectively. For example, the communication components 964 may include a network interface component or another suitable device to interface with the network 980. In further examples, the communication components 964 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 970 may be another machine or any of a wide variety of peripheral devices (e.g., a peripheral device coupled via a USB).

Moreover, the communication components 964 may detect identifiers or include components operable to detect identifiers. For example, the communication components 964 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

### Executable Instructions and Machine Storage Medium

The various memories (i.e., 930, 932, 934, and/or memory of the processor(s) 910) and/or storage unit 936 may store one or more sets of instructions and data structures (e.g., software) embodying or utilized by any one or more of the methodologies or functions described herein. These instructions (e.g., the instructions 916), when executed by processor(s) 910, cause various operations to implement the disclosed embodiments.

As used herein, the terms “machine-storage medium,” “device-storage medium,” “computer-storage medium” mean the same thing and may be used interchangeably in this disclosure. The terms refer to a single or multiple storage devices and/or media (e.g., a centralized or distributed database, and/or associated caches and servers) that store executable instructions and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In various example embodiments, one or more portions of the network 980 may be an ad hoc network, an intranet, an extranet, a VPN, a LAN, a WLAN, a WAN, a WWAN, a MAN, the Internet, a portion of the Internet, a portion of the PSTN, a plain old telephone service (POTS) network, a cellular telephone network, a wireless network, a Wi-Fi® network, another type of network, or a combination of two or more such networks. For example, the network 980 or a portion of the network 980 may include a wireless or cellular network, and the coupling 982 may be a Code Division Multiple Access (CDMA) connection, a Global System for Mobile communications (GSM) connection, or another type of cellular or wireless coupling. In this example, the coupling 982 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 916 may be transmitted or received over the network 980 using a transmission medium via a network interface device (e.g., a network interface component included in the communication components 964) and utilizing any one of a number of well-known transfer protocols (e.g., HTTP). Similarly, the instructions 916 may be transmitted or received using a transmission medium via the coupling 972 (e.g., a peer-to-peer coupling) to the devices 070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 916 for execution by the machine 900, and includes digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a matter as to encode information in the signal.

### Computer-Readable Medium

The terms “machine-readable medium,” “computer-readable medium” and “device-readable medium” mean the same thing and may be used interchangeably in this disclosure. The terms are defined to include both machine-storage media and transmission media. Thus, the terms include both storage devices/media and carrier waves/modulated data signals.

What is claimed is:

1. A computer-implemented method for deriving personalized weighting factors for a cohort of users of an online service, the personalized weighting factors for use in ranking connection recommendations, the method comprising:
using a linear programming problem solver, executing on a processor, to solve an optimization problem formulated with an objective to maximize, for a plurality of destination users, an expected total number of connection invitations sent by a source user to destination users in the plurality of destination users, subject to i) a first constraint requiring an expected number of user-to-user connections made as a result of recommending the plurality of destination users to the source user is equal to or higher than a first threshold, ii) a second constraint requiring an expected total number of downstream impressions associated with connection invitations sent, by the source user, to destination users in the plurality of destination users is equal to or less than a given value, and iii) a third constraint requiring that an expected number of connection invitations sent by the source user to destination users in the plurality of destination users is greater than or equal to a second threshold; and
storing the value of the dual variable in a data record with a user identifier of the destination user for which the value of the dual variable was calculated for subsequent use in deriving a personalized weighting factor when ranking user connection recommendations.

2. The computer-implemented method of claim 1, wherein the source user is a user to whom a plurality of connection recommendations are to be presented, and each destination user in the plurality of destination users is a user that has been categorized as an infrequent user.

3. The computer-implemented method of claim 1, wherein solving the optimization problem with the linear programming problem solver includes calculating, for each pairing of the source user and a destination user in the plurality of destination users, a value for a dual variable of the primal solution of the optimization problem.

4. The computer-implemented method of claim 1, further comprising:
for each user of the online service, processing data in a data log indicating when users log-in to the online service to determine a frequency with which the user has logged in to the online service, and based on the frequency, classifying the user as a frequent user or an infrequent user.

5. The computer-implemented method of claim 1, wherein the value of the dual variable is calculated for a first subset of a set of users classified as infrequent users, the method further comprising:
for each infrequent user in a second subset of users for which a value of the dual variable was not calculated, assigning to the infrequent user a value of a dual variable that was calculated for a particular infrequent user in the first subset of infrequent users, wherein the particular user is determined by comparing an invitation probability score of the particular user with an invitation probability score of the user in the second subset of infrequent users.

6. The computer-implemented method of claim 1, further comprising:
executing a software routine that utilizes a K-means clustering algorithm to cluster groups of users that have been classified as infrequent users, wherein the clustering is based on an invitation probability score that has been derived for each user, the invitation probability score indicating a probability that the user will invite another user to connect;
select from each cluster a predetermined fraction of users to formulate a dataset for use in solving the optimization problem; and
subsequent to calculating, for each pairing of the source user and a destination user in the set of destination users, the value for the dual variable of the primal solution of the optimization problem, assigning to each user in a cluster that was not selected to formulate the dataset a value that is based on a value calculated for another user in the cluster.

7. The computer-implemented method of claim 1, further comprising:
using a machine learned model associated with a first-pass ranker, deriving an invitation probability score for a combination of a source user and a destination user, wherein input data for the machine learned model includes: user profile data for the source user and destination user, activity data for the source user and destination user, and social graph data for the source user and destination user.

8. The computer-implemented method of claim 1, further comprising:
using a machine learned model associated with a first-pass ranker, deriving an acceptance probability score for a combination of a source user and a destination user, wherein input data for the machine learned model include: user profile data for the source user and destination user, activity data for the source user and destination user, and social graph data for the source user and destination user.

9. A system for deriving personalized weighting factors for a cohort of users of an online service, the personalized weighting factors for use in ranking connection recommendations, the system comprising:
a processor; and
a memory storage device storing instructions thereon, which, when executed by the processor, cause the system to:
use a linear programming problem solver, executing on a processor, to solve an optimization problem formulated with an objective to maximize, for a plurality of destination users, an expected total number of connection invitations sent by a source user to destination users in the plurality of destination users, subject to i) a first constraint requiring an expected number of user-to-user connections made as a result of recommending the plurality of destination users to the source user is equal to or higher than a first threshold, ii) a second constraint requiring an expected total number of downstream impressions associated with connection invitations sent, by the source user, to destination users in the plurality of destination users is equal to or less than a given value, and iii) a third constraint requiring that an expected number of connection invitations sent by the source user to destination users in the plurality of destination users is greater than or equal to a second threshold; and
store the value of the dual variable in a data record with a user identifier of the destination user for which the value of the dual variable was calculated for subsequent use in deriving a personalized weighting factor when ranking user connection recommendations.

10. The system of claim 9, wherein the source user is a user to whom a plurality of connection recommendations are to be presented, and each destination user in the plurality of destination users is a user that has been categorized as an infrequent user.

11. The system of claim 9, wherein solving the optimization problem with the linear programming problem solver includes calculating, for each pairing of the source user and a destination user in the plurality of destination users, a value for a dual variable of the primal solution of the optimization problem.

12. The system of claim 9, wherein the memory storage device is storing additional instructions, which, when executed by the processor, cause the system to:
for each user of the online service, process data in a data log indicating when users log-in to the online service to determine a frequency with which the user has logged in to the online service, and based on the frequency, classifying the user as a frequent user or an infrequent user.

13. The system of claim 9, wherein the value of the dual variable is calculated for a first subset of a set of users classified as infrequent users, and the memory storage device is storing additional instructions, which, when executed by the processor, cause the system to:
for each infrequent user in a second subset of users for which a value of the dual variable was not calculated, assign to the infrequent user a value of a dual variable that was calculated for a particular infrequent user in the first subset of infrequent users, wherein the particular user is determined by comparing an invitation probability score of the particular user with an invitation probability score of the user in the second subset of infrequent users.

14. The system of claim 9, wherein the memory storage device is storing additional instructions, which, when executed by the processor, cause the system to:
execute a software routine that utilizes a K-means clustering algorithm to cluster groups of users that have been classified as infrequent users, wherein the clustering is based on an invitation probability score that has been derived for each user, the invitation probability score indicating a probability that the user will invite another user to connect;
select from each cluster a predetermined fraction of users to formulate a dataset for use in solving the optimization problem; and
subsequent to calculating, for each pairing of the source user and a destination user in the set of destination users, the value for the dual variable of the primal solution of the optimization problem, assign to each user in a cluster that was not selected to formulate the dataset a value that is based on a value calculated for another user in the cluster.

15. The system of claim 9, wherein the memory storage device is storing additional instructions, which, when executed by the processor, cause the system to:
use a machine learned model associated with a first-pass ranker, deriving an invitation probability score for a combination of a source user and a destination user, wherein input data for the machine learned model includes: user profile data for the source user and destination user, activity data for the source user and destination user, and social graph data for the source user and destination user.

16. The system of claim 9, wherein the memory storage device is storing additional instructions, which, when executed by the processor, cause the system to:
use a machine learned model associated with a first-pass ranker, derive an acceptance probability score for a combination of a source user and a destination user, wherein input data for the machine learned model include: user profile data for the source user and destination user, activity data for the source user and destination user, and social graph data for the source user and destination user.

17. A system for deriving personalized weighting factors for a cohort of users of an online service, the personalized weighting factors for use in ranking connection recommendations, the system comprising:
means for solving an optimization problem formulated with an objective to maximize, for a plurality of destination users, an expected total number of connection invitations sent by a source user to destination users in the plurality of destination users, subject to i) a first constraint requiring an expected number of user-to-user connections made as a result of recommending the plurality of destination users to the source user is equal to or higher than a first threshold, ii) a second constraint requiring an expected total number of downstream impressions associated with connection invitations sent, by the source user, to destination users in the plurality of destination users is equal to or less than a given value, and iii) a third constraint requiring that an expected number of connection invitations sent by the source user to destination users in the plurality of destination users is greater than or equal to a second threshold;
wherein the source user is a user to whom a plurality of connection recommendations are to be presented, and each destination user in the plurality of destination users is a user that has been categorized as an infrequent user;
wherein solving the optimization problem with the linear programming problem solver includes calculating, for each pairing of the source user and a destination user in the plurality of destination users, a value for a dual variable of the primal solution of the optimization problem; and
means for storing the value of the dual variable in a data record with a user identifier of the destination user for which the value of the dual variable was calculated for subsequent use in deriving a personalized weighting factor when ranking connection recommendations.

18. The system of claim 17, further comprising:
means for processing data in a data log indicating when users log-in to the online service to determine a frequency with which the user has logged in to the online service, and based on the frequency, classifying the user as a frequent user or an infrequent user, for each user of the online service.

19. The system of claim 17, wherein the value of the dual variable is calculated for a first subset of a set of users classified as infrequent users, the system further comprising:
means for assigning to the infrequent user a value of a dual variable that was calculated for a particular infrequent user in the first subset of infrequent users, wherein the particular user is determined by comparing an invitation probability score of the particular user with an invitation probability score of the user in the second subset of infrequent users, for each infrequent user in a second subset of users for which a value of the dual variable was not calculated.

20. The system of claim 17, further comprising:
means for executing a software routine that utilizes a K-means clustering algorithm to cluster groups of users that have been classified as infrequent users, wherein the clustering is based on an invitation probability score that has been derived for each user, the invitation probability score indicating a probability that the user will invite another user to connect;
means for selecting from each cluster a predetermined fraction of users to formulate a dataset for use in solving the optimization problem; and
subsequent to calculating, for each pairing of the source user and a destination user in the set of destination users, the value for the dual variable of the primal solution of the optimization problem, means for assigning to each user in a cluster that was not selected to formulate the dataset a value that is based on a value calculated for another user in the cluster.
